(19) United States
(12) Patent Application Publication
(10) Pub. No.: US 2024/0000029 A1
(43) Pub. Date: Jan. 4, 2024

(54) HYDRATION SYSTEM FOR AN INDOOR GARDEN CENTER

(71) Applicant: Haier US Appliance Solutions, Inc., Wilmington, DE (US)

(72) Inventors: Louis A. Wantland, Louisville, KY (US); Brian Allgeier, Louisville, KY (US); Thibaut Viguier, Prospect, KY (US)

(21) Appl. No.: 17/852,805

(22) Filed: Jun. 29, 2022

(51) Int. Cl. A01G 31/06

(52) U.S. Cl. CPC A01G 31/06; A01G 2031/006

(57) ABSTRACT

A gardening appliance includes a liner positioned within a cabinet and defining a grow chamber, a grow tower rotatably mounted within the liner and defining a root chamber, a primary water supply system for selectively providing freshwater into the root chamber, and an auxiliary water supply system comprising a wastewater tank for storing wastewater and selectively providing the wastewater into the root chamber. A controller is configured to determine that a hydration cycle needs to be performed to hydrate the one or more plant pods, determine that a freshwater supply limitation exists (e.g., an empty water supply tank or a full wastewater tank), and operate the auxiliary water supply system to provide the wastewater from the wastewater tank into the root chamber in response to determining that the freshwater supply limitation exists when the hydration cycle is needed.

### FIELD OF THE INVENTION

The present subject matter relates generally to systems for gardening plants indoors, and more particularly, to hydration systems for use in indoor gardening appliances.

### BACKGROUND OF THE INVENTION

Conventional indoor garden centers include a cabinet defining a grow chamber having a number of trays or racks positioned therein to support seedlings or plant material, e.g., for growing herbs, vegetables, or other plants in an indoor environment. In addition, such indoor garden centers may include an environmental control system that maintains the growing chamber at a desired temperature or humidity. Certain indoor garden centers may also include hydration systems for watering the plants and/or artificial lighting systems that provide the light necessary for such plants to grow.

Conventional indoor gardens centers typically include a hydration system for providing a flow of water and nutrients onto plants stored therein to facilitate plant growth. For example, typical garden centers may include a removable and refillable supply tank that a user periodically refills with freshwater. During a hydration cycle, freshwater is pumped from the supply tank to hydrate plants, with excess water collecting in the sump and being stored in a wastewater reservoir. However, if supply tank is not replenished when empty, the plants stored in the garden center may not be watered, resulting in poor plant growth or death. In addition, if the wastewater reservoir is not emptied when full, the supply of freshwater may need to be stopped to prevent overfilling the wastewater tank.

Accordingly, an improved indoor garden center would be useful. More particularly, an indoor garden center with a hydration system that improves the utilization of available water sources would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a gardening appliance defining a vertical direction is provided. The gardening appliance includes a liner positioned within a cabinet and defining a grow chamber, a grow tower rotatably mounted within the liner, the grow tower defining a root chamber and a plurality of apertures for receiving one or more plant pods, a primary water supply system for selectively providing freshwater into the root chamber, an auxiliary water supply system comprising a wastewater tank for storing wastewater and selectively providing the wastewater into the root chamber, and a controller in operative communication with the primary water supply system and the auxiliary water supply system. The controller is configured to determine that a hydration cycle needs to be performed to hydrate the one or more plant pods, determine that a freshwater supply limitation exists, and operate the auxiliary water supply system to provide the wastewater from the wastewater tank into the root chamber in response to determining that the freshwater supply limitation exists when the hydration cycle is needed.

In another exemplary embodiment, a hydration system for a gardening appliance is provided. The gardening appliance includes a liner positioned within a cabinet and a grow tower rotatably mounted within the liner, the grow tower defining a root chamber and a plurality of apertures for receiving one or more plant pods. The hydration system includes a primary water supply system for selectively providing freshwater into the root chamber, an auxiliary water supply system comprising a wastewater tank for storing wastewater and selectively providing the wastewater into the root chamber, and a controller in operative communication with the primary water supply system and the auxiliary water supply system. The controller is configured to determine that a hydration cycle needs to be performed to hydrate the one or more plant pods, determine that a freshwater supply limitation exists, and operate the auxiliary water supply system to provide the wastewater from the wastewater tank into the root chamber in response to determining that the freshwater supply limitation exists when the hydration cycle is needed.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a gardening appliance according to an exemplary embodiment of the present subject matter.

FIG. 2 depicts a front view of the exemplary gardening appliance of FIG. 1 with the doors open according to an exemplary embodiment of the present subject matter.

FIG. 3 is a cross sectional view of the exemplary gardening appliance of FIG. 1, taken along Line 3-3 from FIG. 2.

FIG. 4 is a top perspective view of the exemplary gardening appliance of FIG. 1, with a top panel and doors removed according to an exemplary embodiment of the present subject matter.

FIG. 5 is a perspective cross-sectional view of the exemplary gardening appliance of FIG. 1, taken along Line 5-5 from FIG. 2.

FIG. 6 is a top cross-sectional view of the exemplary gardening appliance of FIG. 1, taken along Line 5-5 from FIG. 2.

FIG. 7 provides a perspective view of a grow tower of the exemplary gardening appliance of FIG. 1 according to an exemplary embodiment of the present subject matter.

FIG. 8 provides a front schematic view of the exemplary gardening appliance of FIG. 1 and a hydration system according to an exemplary embodiment of the present subject matter.

FIG. 9 provides a method of operating a hydration system of an indoor gardening appliance according to an exemplary embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

Referring now to the figures, a gardening appliance 100 will be described in accordance with exemplary aspects of the present subject matter. According to exemplary embodiments, gardening appliance 100 may be used as an indoor garden center for growing plants. It should be appreciated that the embodiments described herein are intended only for explaining aspects of the present subject matter. Variations and modifications may be made to gardening appliance 100 while remaining within the scope of the present subject matter.

According to exemplary embodiments, gardening appliance 100 includes a cabinet 102 that is generally configured for containing and/or supporting various components of gardening appliance 100 and which may also define one or more internal chambers or compartments of gardening appliance 100. In this regard, as used herein, the terms “cabinet,” “housing,” and the like are generally intended to refer to an outer frame or support structure for gardening appliance 100, e.g., including any suitable number, type, and configuration of support structures formed from any suitable materials, such as a system of elongated support members, a plurality of interconnected panels, or some combination thereof. It should be appreciated that cabinet 102 does not necessarily require an enclosure and may simply include open structure supporting various elements of gardening appliance 100. By contrast, cabinet 102 may enclose some or all portions of an interior of cabinet 102. It should be appreciated that cabinet 102 may have any suitable size, shape, and configuration while remaining within the scope of the present subject matter.

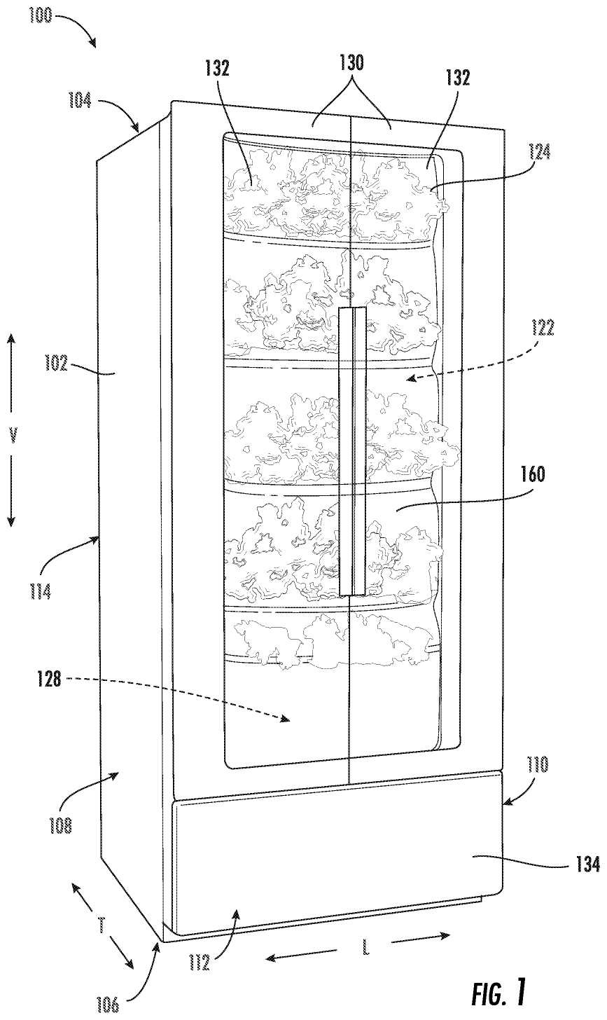

As illustrated, gardening appliance 100 generally defines a vertical direction V, a lateral direction L, and a transverse direction T, each of which is mutually perpendicular, such that an orthogonal coordinate system is generally defined. The horizontal direction is generally intended to refer to a direction perpendicular to the vertical direction V (e.g., within a plane defined by the lateral direction L and the transverse direction T). Cabinet 102 generally extends between a top 104 and a bottom 106 along the vertical direction V, between a first side 108 (e.g., the left side when viewed from the front as in FIG. 1) and a second side 110 (e.g., the right side when viewed from the front as in FIG. 1) along the lateral direction L, and between a front 112 and a rear 114 along the transverse direction T. In general, terms such as “left,” “right,” “front,” “rear,” “top,” or “bottom” are used with reference to the perspective of a user accessing gardening appliance 100.

Gardening appliance 100 may include an insulated liner 120 positioned within cabinet 102. Liner 120 may at least partially define an internal temperature-controlled chamber, referred to herein generally as a climate-controlled chamber 122, within which plants 124 may be grown. Although gardening appliance 100 is referred to herein as growing plants 124, it should be appreciated that other organisms or living things may be grown or stored in gardening appliance 100. For example, algae, fungi (e.g., including mushrooms), or other living organisms may be grown or stored in gardening appliance 100. The specific application described herein is not intended to limit the scope of the present subject matter in any manner.

Cabinet 102, or more specifically, liner 120 may define a substantially enclosed back portion 126 (e.g., proximate rear 114 of cabinet 102). In addition, cabinet 102 and liner 120 may define a front opening, referred to herein as front display opening 128 (e.g., proximate front 112 of cabinet 102), through which a user of gardening appliance 100 may access climate-controlled chamber 122, e.g., for harvesting, planting, pruning, or otherwise interacting with plants 124. According to an exemplary embodiment, enclosed back portion 126 may be defined as a portion of liner 120 that defines climate-controlled chamber 122 proximate rear side 114 of cabinet 102. In addition, front display opening 128 may generally be positioned proximate or coincide with front side 112 of cabinet 102.

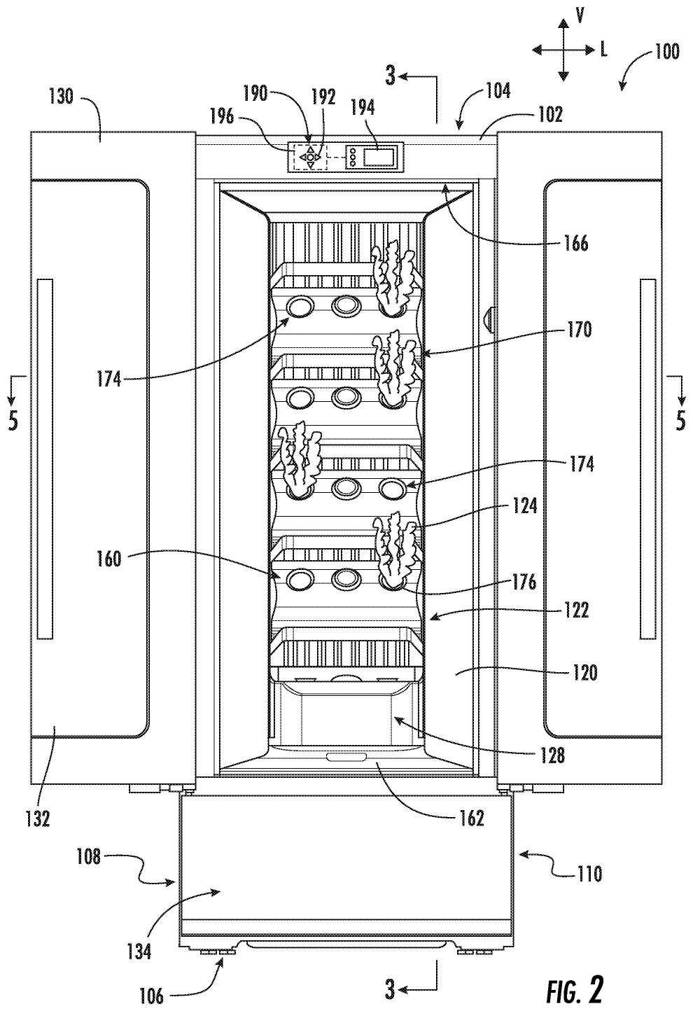

Gardening appliance 100 may further include one or more doors 130 that are rotatably mounted to cabinet 102 for providing selective access to climate-controlled chamber 122. For example, FIG. 1 illustrates doors 130 in the closed position such that they may help insulate climate-controlled chamber 122. By contrast, FIG. 2 illustrates doors 130 in the open positioned to permit access to climate-controlled chamber 122 and plants 124 stored therein. Doors 130 may further include a transparent window 132 through which a user may observe plants 124 without opening doors 130.

Although doors 130 are illustrated as being rectangular and being mounted on front side 112 of cabinet 102 in FIGS. 1 and 2, it should be appreciated that according to alternative embodiments, doors 130 may have different shapes, mounting locations, etc. For example, doors 130 may be curved, may be formed entirely from glass, etc. In addition, doors 130 may have integral features for controlling light passing into and/or out of climate-controlled chamber 122, such as internal louvers, tinting, UV treatments, polarization, etc. One skilled in the art will appreciate that other chamber and door configurations are possible and within the scope of the present subject matter.

According to the illustrated embodiment, cabinet 102 further defines a drawer 134 positioned proximate bottom 106 of cabinet 102 and being slidably mounted to cabinet 102 for providing convenient storage for plant nutrients, system accessories, water filters, etc. In addition, behind drawer 134 is a mechanical compartment 136 for receipt of an environmental control system including a sealed system for regulating the temperature within climate-controlled chamber 122, as described in more detail below.

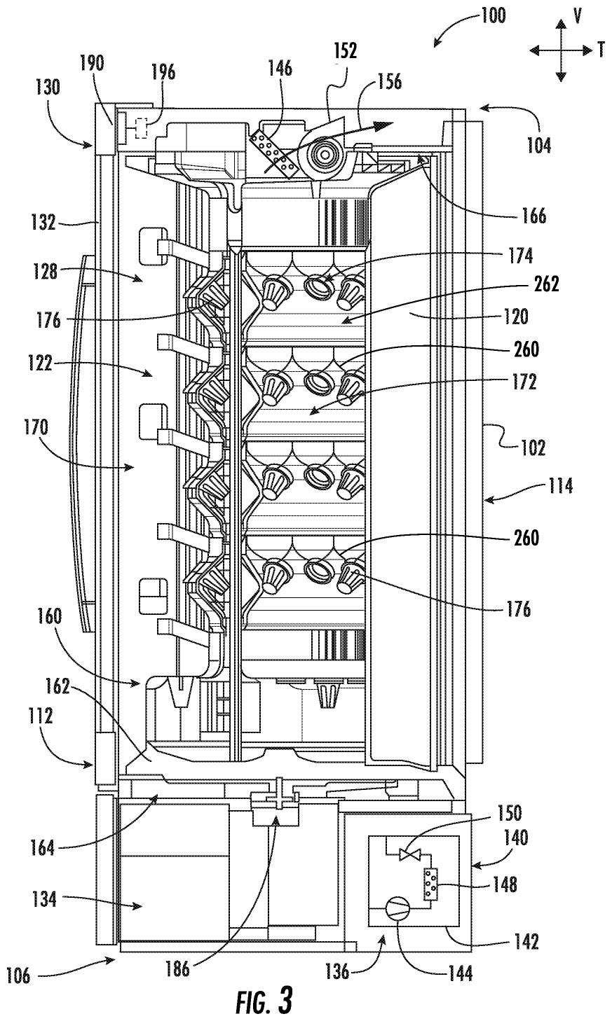

FIG. 3 provides a schematic view of certain components of an environmental control system 140 that may be used to regulate a climate or environment within climate-controlled chamber 122. Specifically, environmental control system 140 may include one or more subsystems for regulating temperature, humidity, hydration, nutrient dosing, lighting, and any other aspects of the environment within one or more portions of climate-controlled chamber 122, e.g., as desired to facilitate improved or regulated growth of plants 124 positioned therein. Although exemplary subsystems and subsystem configurations are described below, it should be appreciated that aspects of environmental control system 140 may vary while remaining within the scope of the present subject matter.

As illustrated, environmental control system 140 includes a sealed system 142 that is generally configured for regulating a temperature and/or humidity within one or more regions of climate-controlled chamber 122. In this regard, as shown schematically in FIG. 3, sealed system 142 may be located partially within mechanical compartment 136 and includes a compressor 144, a first heat exchanger or evaporator 146 and a second heat exchanger or condenser 148. As is generally understood, compressor 144 is generally operable to circulate or urge a flow of refrigerant through sealed system 142, which may include various conduits which may be utilized to flow refrigerant between the various components of sealed system 142. Thus, evaporator 146 and condenser 148 may be between and in fluid communication with each other and compressor 144.

During operation of sealed system 142, refrigerant flows from evaporator 146 and to compressor 144. For example, refrigerant may exit evaporator 146 as a fluid in the form of a superheated vapor. Upon exiting evaporator 146, the refrigerant may enter compressor 144, which is operable to compress the refrigerant and direct the compressed refrigerant to condenser 148. Accordingly, the pressure and temperature of the refrigerant may be increased in compressor 144 such that the refrigerant becomes a more superheated vapor.

Condenser 148 is disposed downstream of compressor 144 and is operable to reject heat from the refrigerant. For example, the superheated vapor from compressor 144 may enter condenser 148 and transfer energy to air surrounding condenser 148 (e.g., to create a flow of heated air). In this manner, the refrigerant condenses into a saturated liquid and/or liquid vapor mixture. A condenser fan (not shown) may be positioned adjacent condenser 148 and may facilitate or urge the flow of heated air across the coils of condenser 148 (e.g., from ambient atmosphere) in order to facilitate heat transfer.

According to the illustrated embodiment, an expansion device or a variable electronic expansion valve 150 may be further provided to regulate refrigerant expansion. During use, variable electronic expansion valve 150 may generally expand the refrigerant, lowering the pressure and temperature thereof. In this regard, refrigerant may exit condenser 148 in the form of high liquid quality/saturated liquid vapor mixture and travel through variable electronic expansion valve 150 before flowing through evaporator 146. Variable electronic expansion valve 150 is generally configured to be adjustable, e.g., such that the flow of refrigerant (e.g., volumetric flow rate in milliliters per second) through variable electronic expansion valve 150 may be selectively varied or adjusted.

Evaporator 146 is disposed downstream of variable electronic expansion valve 150 and is operable to heat refrigerant within evaporator 146, e.g., by absorbing thermal energy from air surrounding the evaporator (e.g., to create a flow of cooled air). For example, the liquid or liquid vapor mixture refrigerant from variable electronic expansion valve 150 may enter evaporator 146. Within evaporator 146, the refrigerant from variable electronic expansion valve 150 receives energy from the flow of cooled air and vaporizes into superheated vapor and/or high-quality vapor mixture. An air handler or evaporator fan 152 is positioned adjacent evaporator 146 and may facilitate or urge the flow of cooled air across evaporator 146 in order to facilitate heat transfer. From evaporator 146, refrigerant may return to compressor 144 and the vapor-compression cycle may continue.

As explained above, environmental control system 140 includes a sealed system 142 for providing a flow of heated air or a flow cooled air throughout climate-controlled chamber 122 as needed. To direct this air, environmental control system 140 may include a duct system 154 for directing the flow of temperature regulated air, identified herein simply as flow of air 156 (see, e.g., FIG. 3). In this regard, for example, evaporator fan 152 can generate a flow of cooled air as the air passes over evaporator 146 and a condenser fan (not shown) can generate a flow of heated air as the air passes over condenser 148.

This temperature-regulated flow of air 156 may be routed through a cooled air supply duct and/or heated air may be routed through a heated air supply duct (not shown). In this regard, it should be appreciated that environmental control system 140 may generally include a plurality of ducts, dampers, diverter assemblies, and/or air handlers to facilitate operation in a cooling mode, in a heating mode, in both a heating and cooling mode, or any other mode suitable for regulating the environment within climate-controlled chamber 122. It should be appreciated that duct system 154 may vary in complexity and may regulate the flows of air from sealed system 142 in any suitable arrangement through any suitable portion of climate-controlled chamber 122.

Although an exemplary sealed system 142 and duct system 154 are illustrated and described herein, it should be appreciated that variations and modifications may be made to sealed system 142 and/or duct system 154 while remaining within the scope of the present subject matter. For example, sealed system 142 may include additional or alternative components, duct system 154 may include additional or different ducting configurations, etc. For example, according to the illustrated embodiment, evaporator 146 and evaporator fan 152 may be positioned at top 104 of cabinet 102 and refrigerant may be routed from mechanical compartment 136 and through cabinet 102 to evaporator 146. In addition, it should be appreciated that gardening appliance 100 may have one or more subsystems integrated with or operably coupled to duct system 154 for filtering the flow of air 156, regulating the concentration of one or more gases within the flow of air 156, etc.

Referring now generally to FIGS. 1 through 7, gardening appliance 100 generally includes a rotatable carousel, referred to herein as a grow tower 160 that is mounted within liner 120, e.g., such that it is within climate-controlled chamber 122.

More specifically, grow tower 160 may be positioned on top of a turntable 162 that is rotatably mounted to a sump 164 of gardening appliance 100. In general, grow tower 160 extends along the vertical direction V from sump 164 to a top wall 166 of climate-controlled chamber 122.

In addition, grow tower 160 is generally rotatable about a central axis 168 defined by turntable 162. Specifically, according to the illustrated embodiment, central axis 168 is parallel to the vertical direction V. However, it should be appreciated that central axis 168 could alternatively extend in any suitable direction, e.g., such as the horizontal direction (e.g., defined by the lateral direction L and the transverse direction T). In this regard, grow tower 160 generally defines an axial direction A, i.e., parallel to central axis 168, a radial direction R that extends perpendicular to central axis 168, and a circumferential direction C that extends around central axis 168 (e.g., in a plane perpendicular to central axis 168).

As illustrated, grow tower 160 may generally separate, divide, or partition climate-controlled chamber 122 into a plurality of grow chambers (e.g., identified generally by reference numeral 170). More specifically, grow chambers 170 are generally defined between grow tower 160 and liner 120 or between grow tower 160 and doors 130. In general, grow chambers 170 are intended to support the leafy growth of plants 124 (e.g., or other portions of plants 124 other than the plant roots). According to the illustrated embodiment, grow tower 160 divides climate control chamber 122 into three grow chambers 170, referred to herein generally as a first chamber, a second chamber, and a third chamber. As illustrated, these grow chambers 170 are circumferentially spaced relative to each other and define substantially separate and distinct growing environments. As such, each grow chamber 170 may receive plants 124 having different growth needs and the grow environment within each respective grow chamber 170 may be maintained as grow tower 160 is rotated within climate-controlled chamber 122.

In addition, according to the illustrated embodiment, grow tower 160 may generally define an internal chamber, referred to herein as a root chamber 172. In general, root chamber 172 may be substantially sealed relative to (or isolated from) grow chambers 170 and is configured for containing the roots of plants 124 throughout the growing process. As will be described in more detail below, grow tower 160 may generally define one or more apertures 174 that are defined through grow tower 160 to permit access between grow chambers 170 and root chamber 172. According to exemplary embodiments, these apertures 174 may be configured to receive plant pods 176 into root chamber 172.

Plant pods 176 generally contain seedlings, root balls, or other plant material for growing plants 124 positioned within a mesh or other support structure through which roots of plants 124 may grow within grow tower 160. A user may insert a portion of plant pod 176 (e.g., a seed end or root end) having the desired seeds through one of the plurality of apertures 174 into root chamber 172. A plant end (e.g., opposite the root end) of the plant pod 176 may remain within grow chamber 170 such that plants 124 may grow from grow tower 160 such that they are accessible by a user.

As will be explained below, water and other nutrients may be supplied to the root end of plant pods 176 within root chamber 172. For example, a hydration system may be configured to provide a flow of hydrating mist including water, nutrients, and other suitable constituents for providing the desirable growth environment for plants 124. According to exemplary embodiments, apertures 174 may be covered by a flat flapper seal or seal cap (not shown) to prevent hydrating mist from escaping root chamber 172 when no plant pod 176 is installed and to facilitate improved climate control within root chamber 172 and grow chambers 170. In addition, according to the illustrated embodiment, root chamber 172 may be operably coupled with sealed system 142 for facilitating suitable climate control within the root chamber 172, e.g., to achieve desirable growing conditions.

Although grow tower 160 described and illustrated above includes a single root chamber 172, it should be appreciated that according to alternative exemplary embodiments, grow tower 160 may further include one or more internal dividers (not shown) that are positioned within root chamber 172 to divide root chamber 172 into a plurality of sub-chambers or root chambers. Each of these root chambers may be partially or substantially isolated from the other root chambers to facilitate independent climate control, hydration, gas regulation, etc. In addition, each of these root chambers may be in fluid communication with one of the plurality of grow chambers 170 through the plurality of apertures 174.

Notably, it may be desirable according to exemplary embodiments to form a fluid-tight seal between the grow tower 160 and liner 120. In this manner, as grow tower 160 rotates within climate-controlled chamber 122, grow chambers 170 may remain fluidly isolated from each other. Therefore, according to an exemplary embodiment, grow tower 160 may generally define a grow module diameter (e.g., defined by its substantially circular footprint formed in a horizontal plane). Similarly, enclosed back portion 126 of liner 120 may be substantially cylindrical and may define a liner diameter (not labeled). In order to prevent a significant amount of air from escaping between grow tower 160 and liner 120, and in order to fluidly isolate the various grow chambers 170, the liner diameter may be substantially equal to or slightly larger than the grow module diameter.

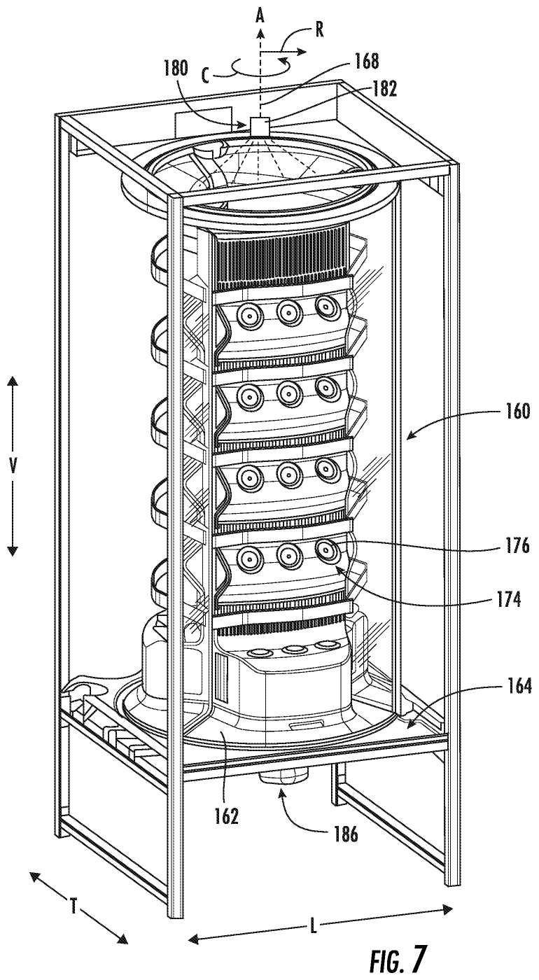

As best shown in FIG. 7, environmental control system 140 may further include a hydration system 180 which is generally configured for providing water and/or nutrients to plants 124 to support their growth. Specifically, according to the illustrated embodiment, hydration system 180 may be fluidly coupled to a water supply and or nutrient distribution assembly to selectively provide desirable quantities and concentrations of hydration, nutrients, and/or other fluids onto plants 124 to facilitate improved plant growth. For example, hydration system 180 includes misting device 182 (e.g., such as a fine mist spray nozzle or nozzles) that is fluidly coupled to a water supply (not shown). For example, the water supply may be a reservoir containing water (e.g., distilled water) or may be a direct connection municipal water supply. According to exemplary embodiments, hydration system 180 may include one or more pumps (not shown) for providing a flow of liquid nutrients to misting device 182. In this regard, for example, water or nutrients that are not absorbed by roots of plants 124 may fall under the force of gravity into sump 164 and these pumps may be fluidly coupled to sump 164 to recirculate the water through misting device 182.

According to the illustrated embodiment, misting device 182 is positioned at a top of root chamber 172 and may be configured for charging root chamber 172 with mist for hydrating the roots of plants 124. Alternatively, misting devices 182 may be positioned at a bottom of root chamber 172 (e.g., within sump 164) for spraying a mist or water into root chamber 172. Because various plants 124 may require different amounts of water for desired growth, hydration system 180 may alternatively include a plurality of misting devices 182, e.g., all coupled to the water supply and/or nutrient supplies. This plurality of misting devices 182 may be spaced apart at along the vertical direction V within root chamber 172. In this manner, these misting devices 182 may provide different concentrations of hydration and/or nutrients to different regions within root chamber 172.

Notably, environmental control system 140 described above is generally configured for regulating the temperature and humidity (e.g., or some other suitable water level quantity or measurement) within one or all of the plurality of chambers 170 and/or root chambers 172 independently of each other. In this manner, a versatile and desirable growing environment may be obtained for each and every chamber 170.

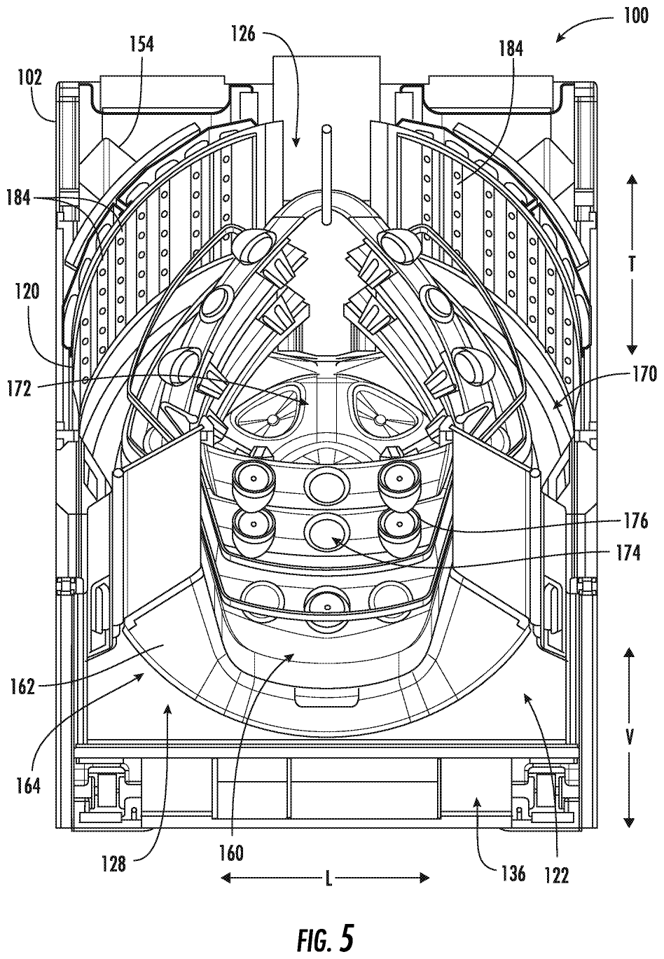

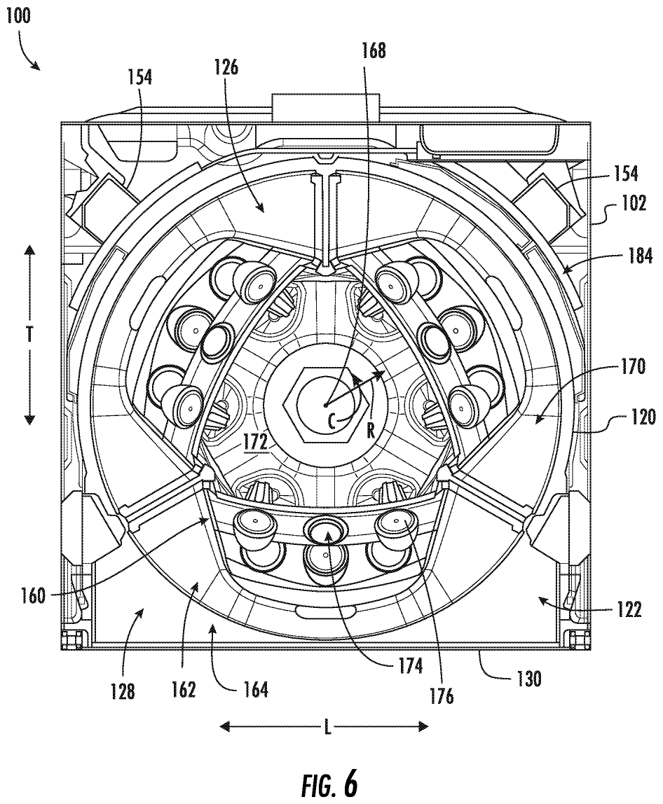

Referring now for example to FIGS. 5 and 6, gardening appliance 100 may further include a light assembly 184 which is generally configured for providing light into selected grow chambers 170 to facilitate photosynthesis and growth of plants 124. As shown, light assembly 184 may include a plurality of light sources (not labeled) stacked in an array, e.g., extending along the vertical direction V. For example, light assembly 184 may be mounted directly to liner 120 within climate-controlled chamber 122 or may alternatively be positioned behind liner 120 such that light is projected through a transparent window or light pipe into climate-controlled chamber 122. The position, configuration, and type of light sources described herein are not intended to limit the scope of the present subject matter in any manner.

Light assembly 184 may include any suitable number, type, position, and configuration of electrical light source(s), using any suitable light technology and illuminating in any suitable color. For example, according to the illustrated embodiment, light assembly 184 includes one or more light emitting diodes (LEDs), which may each illuminate in a single color (e.g., white LEDs), or which may each illuminate in multiple colors (e.g., multi-color or RGB LEDs) depending on the control signal from controller 196. However, it should be appreciated that according to alternative embodiments, light assembly 184 may include any other suitable traditional light bulbs or sources, such as halogen bulbs, fluorescent bulbs, incandescent bulbs, glow bars, a fiber light source, etc.

As explained above, light generated from light assembly 184 may result in light pollution within a room where gardening appliance 100 is located. Therefore, aspects of the present subject matter are directed to features for reducing light pollution, or to the blocking of light from light assembly 184 through front display opening 128. Specifically, as illustrated, light assembly 184 is positioned only within the enclosed back portion 126 of liner 120 such that only grow chambers 170 which are in a sealed position are exposed to light from light assembly 184. Specifically, grow tower 160 acts as a physical partition between light assemblies 184 and front display opening 128. In this manner, as illustrated in FIG. 5, no light may pass from the first or second grow chambers 170 (i.e., the “rear” or enclosed grow chambers 170) through grow tower 160 and out through front display opening 128. As grow tower 160 rotates, two of the three grow chambers 170 will receive light from light assembly 184 at a time. According to still other embodiments, a single light assembly may be used to reduce costs, whereby only a single grow chamber 170 will be illuminated at a single time.

Referring now specifically to FIGS. 3 and 7, gardening appliance 100 may further include a motor assembly 186 or another suitable driving element or device for selectively rotating grow tower 160 during operation of gardening appliance 100. In this regard, according to the illustrated embodiment, motor assembly 186 is positioned below grow tower 160, e.g., within mechanical compartment 136, and may be mechanically coupled to turntable 162 for selectively rotating turntable 162 and grow tower 160 about central axis 168.

As used herein, “motor” may refer to any suitable drive motor and/or transmission assembly for rotating turntable 162 and grow tower 160. For example, motor assembly 186 may include a brushless DC electric motor, a stepper motor, or any other suitable type or configuration of motor. For example, motor assembly 186 may include an AC motor, an induction motor, a permanent magnet synchronous motor, or any other suitable type of AC motor. In addition, motor assembly 186 may include any suitable transmission assemblies, clutch mechanisms, or other components.

Referring again to FIG. 2, gardening appliance 100 may include a control panel 190 that may represent a general-purpose Input/Output (“GPIO”) device or functional block for gardening appliance 100. In some embodiments, control panel 190 may include or be in operative communication with one or more user input devices 192, such as one or more of a variety of digital, analog, electrical, mechanical, or electro-mechanical input devices including rotary dials, control knobs, push buttons, toggle switches, selector switches, and touch pads.

Additionally, gardening appliance 100 may include a display 194, such as a digital or analog display device generally configured to provide visual feedback regarding the operation of gardening appliance 100. For example, display 194 may be provided on control panel 190 and may include one or more status lights, screens, or visible indicators. According to exemplary embodiments, user input devices 192 and display 194 may be integrated into a single device, e.g., including one or more of a touchscreen interface, a capacitive touch panel, a liquid crystal display (LCD), a plasma display panel (PDP), a cathode ray tube (CRT) display, or other informational or interactive displays.

Gardening appliance 100 may further include or be in operative communication with a processing device or a controller 196 that may be generally configured to facilitate appliance operation. In this regard, control panel 190, user input devices 192, and display 194 may be in communication with controller 196 such that controller 196 may receive control inputs from user input devices 192, may display information using display 194, and may otherwise regulate operation of gardening appliance 100. For example, signals generated by controller 196 may operate gardening appliance 100, including any or all system components, subsystems, or interconnected devices, in response to the position of user input devices 192 and other control commands. Control panel 190 and other components of gardening appliance 100 may be in communication with controller 196 via, for example, one or more signal lines or shared communication busses. In this manner, Input/Output (“I/O”) signals may be routed between controller 196 and various operational components of gardening appliance 100.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 196 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 196 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware.

Additionally, or alternatively, the instructions can be executed logically and/or virtually using separate threads on one or more processors.

For example, controller 196 may be operable to execute programming instructions or micro-control code associated with an operating cycle of gardening appliance 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 196 as disclosed herein is capable of and may be operable to perform any methods, method steps, or portions of methods as disclosed herein. For example, in some embodiments, methods disclosed herein may be embodied in programming instructions stored in the memory and executed by controller 196.

The memory devices may also store data that can be retrieved, manipulated, created, or stored by the one or more processors or portions of controller 196. The data can include, for instance, data to facilitate performance of methods described herein. The data can be stored locally (e.g., on controller 196) in one or more databases and/or may be split up so that the data is stored in multiple locations. In addition, or alternatively, the one or more database(s) can be connected to controller 196 through any suitable network(s), such as through a high bandwidth local area network (LAN) or wide area network (WAN). In this regard, for example, controller 196 may further include a communication module or interface that may be used to communicate with one or more other component(s) of gardening appliance 100, controller 196, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

According to an exemplary embodiment, motor assembly 186 may be operably coupled to controller 196, which is programmed to rotate grow tower 160 according to predetermined operating cycles, based on user inputs (e.g., via touch buttons 192), etc. In addition, controller 196 may be communicatively coupled to one or more sensors, such as temperature or humidity sensors, positioned within the various chambers 170 for measuring temperatures and/or humidity, respectively. Controller 196 may then operate motor assembly 186 in order to maintain desired environmental conditions for each of the respective chambers 170. For example, as described herein, gardening appliance 100 includes features or subsystems for providing certain locations of gardening appliance 100 with light, temperature control, proper moisture, nutrients, and other requirements for suitable plant growth. Motor assembly 186 may be used to position specific chambers 170 where needed to receive such growth requirements.

According to an exemplary embodiment, such as where grow tower 160 divides climate-controlled chamber 122 into three grow chambers 170, controller 196 may operate motor assembly 186 to index grow tower 160 sequentially through a number of preselected positions. More specifically, motor assembly 186 may rotate grow tower 160 in a counterclockwise direction (e.g., when viewed from a top of grow tower 160) in 120° increments to move chambers 170 between sealed positions and display positions. As used herein, a chamber 170 is considered to be in a “sealed position” when that chamber 170 is substantially sealed between grow tower 160 and liner 120. By contrast, a chamber 170 is considered to be in a “display position” when that chamber 170 is at least partially exposed to front display opening 128, such that a user may access plants 124 positioned within that chamber 170.

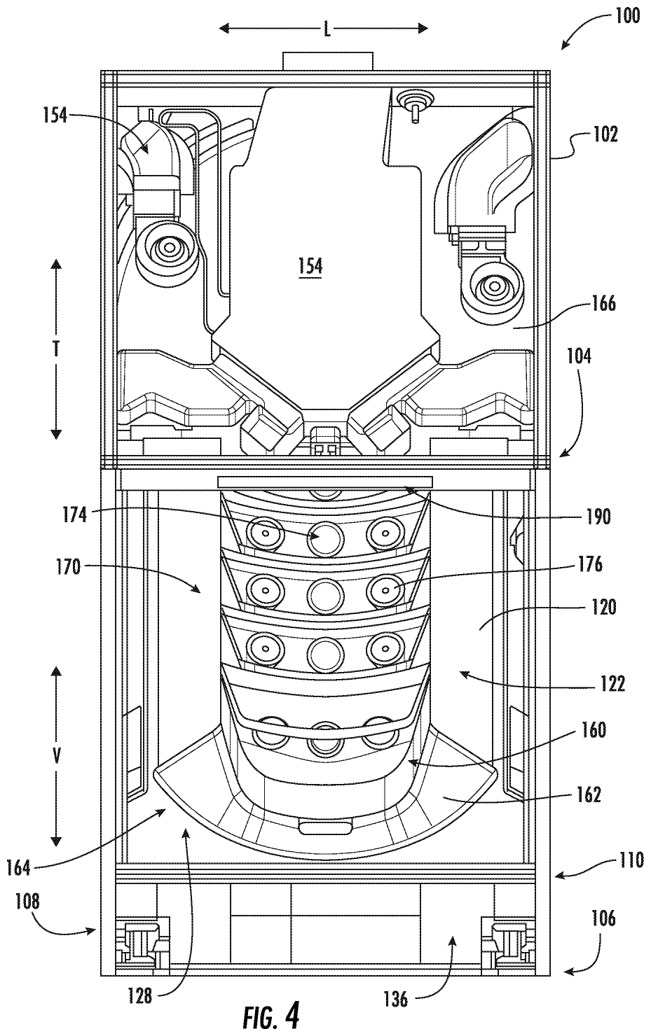

For example, as illustrated in FIGS. 4 and 5, the first grow chamber and the second grow chamber (i.e., the rear chambers) are both in a sealed position, whereas the third grow chamber (i.e., the front chamber) is in a display position. As motor assembly 186 rotates grow tower 160 by 120 degrees in the counterclockwise direction, the second grow chamber will enter the display position, while the first grow chamber and the third grow chamber will be in the sealed positions. Motor assembly 186 may continue to rotate grow tower 160 in such increments to cycle grow chambers 170 between these sealed and display positions.

Gardening appliance 100 and grow tower 160 have been described above to explain an exemplary embodiment of the present subject matter. However, it should be appreciated that variations and modifications may be made while remaining within the scope of the present subject matter. For example, according to alternative embodiments, gardening appliance 100 may be a simplified to a two-chamber embodiment with a square liner 120 and a grow tower 160 that divides the climate-controlled chamber 122 in half to define a first grow chamber and a second grow chamber. According to such an embodiment, by rotating grow tower 160 by 180 degrees about central axis 168, the first chamber may alternate between the sealed position (e.g., facing rear side 114 of cabinet 102) and the display position (e.g., facing front side 112 of cabinet 102). By contrast, the same rotation will move the second chamber from the display position to the sealed position.

According to still other embodiments, gardening appliance 100 may include a three chamber grow tower 160 but may have a modified cabinet 102 such that front display opening 128 is wider and two of the three grow chambers 170 are displayed at a single time. Thus, the first grow chamber may be in the sealed position, while the second grow chamber and the third grow chamber may be in the display positions. As grow tower 160 is rotated counterclockwise, the first grow chamber is moved into the display position and the third grow chamber is moved into the sealed position.

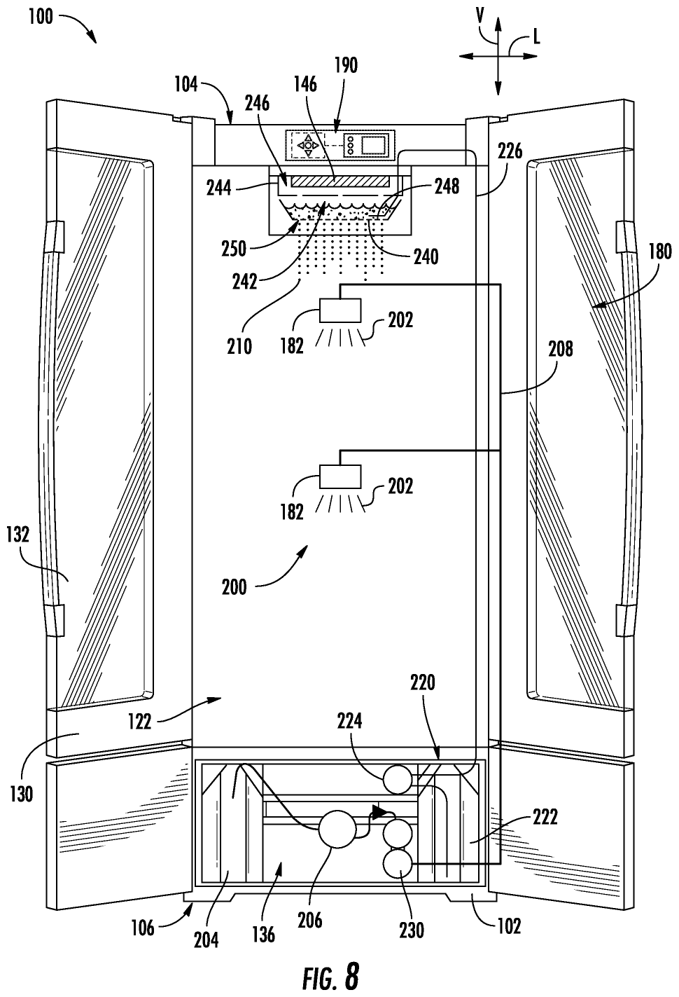

Referring now generally to FIG. 8, hydration system 180 will be described in more detail according to exemplary embodiments of the present subject matter. In this regard, FIG. 8 provides a front view of gardening appliance 100 with grow tower 160 removed for clarity according to example embodiments. Although an exemplary hydration system 180 will be described herein as being used with the exemplary gardening appliance 100, it should be appreciated that variations to hydration system 180 may be made and hydration system may be used in different gardening appliances while remaining within the scope of the present subject matter.

According to the illustrated embodiment, hydration system 180 may generally include a primary water supply system 200. In general, primary water supply system 200 is designed and configured for selectively providing freshwater (e.g., as indicated by reference numeral 202 in FIG. 8) into root chamber 172 for hydrating plants 124 under normal operating conditions. As explained in more detail below, normal operating conditions for hydration system 200 may generally refer to situations where there is a sufficient supply of water to hydrate plants and there is a sufficient amount of wastewater storage for holding wastewater that is not used by plants 124.

Specifically, according to an exemplary embodiment, hydration system 180 includes a water supply tank 204 that contains freshwater 202, such as pure tap water, distilled water, or water from any other external fluid supply source. According to the illustrated embodiment, water supply tank 204 is a removable water storage tank that may be filled by a user and that is contained within cabinet 102. In this regard, a user may periodically remove water supply tank 204 and fill it with freshwater 202 or may otherwise fluidly couple a water supply for periodically replenishing freshwater within water supply tank 204. According to alternative embodiments, water supply tank may be replaced by or coupled to a municipal water supply that provides a flow of pressurized water into hydration system 180. It should be appreciated that water supply tank 204 may include any suitable pumps, flow regulating valves, or other flow regulating devices needed to regulate the flow of freshwater 202.

According to exemplary embodiments, hydration system 180 may include any suitable number and configuration of pumps, devices, or mechanisms for selectively urging the nutrient mixture or the flow of liquid onto plants 124. For example, according to the illustrated embodiment, hydration system 180 includes a freshwater supply pump 206 that is fluidly coupled to a supply conduit 208 for selectively pressurizing and urging a flow of water and/or other nutrients (e.g., referred to herein as freshwater 202) through supply conduit 208.

In addition, as explained above, hydration system 180 includes one or more discharge nozzles or misting nozzles 182 that are in fluid communication with supply conduit 208. Thus, freshwater supply pump 206 may be configured for selectively operating to provide the freshwater 202 through misting nozzles 182 into root chamber 172 and/or climate-controlled chamber 122 to hydrate plants 124. Although one exemplary configuration of discharge nozzles 182 is described herein, it should be appreciated that discharge nozzles 182 may include any other suitable number, type, configuration, and position of devices for supplying water, hydration, or other nutrients to plants 124 (e.g., such as a two-nozzle configuration illustrated in FIG. 8).

As explained briefly above, freshwater 202 that is supplied into root chamber 172 to hydrate plants 124 is not commonly absorbed or used completely by plants 124. As a result, a certain portion of freshwater 202 may drip off of the roots of plants 124 or may drip down the walls of grow tower 160. This water, referred to herein as wastewater 210, generally falls under the force of gravity down to sump 164 where it is collected. As described in more detail below, hydration system 180 may include an auxiliary water supply system 220 that is generally configured for collecting wastewater 210 and using it in situations where freshwater 202 cannot or should not be supplied.

Referring still to FIG. 8, auxiliary water supply system 220 may generally include a wastewater tank 222 that is fluidly coupled to sump 164 for collecting and storing wastewater 210. Similar to primary water supply system 200, auxiliary water supply system 220 may include the same or similar pumps, valves, and other flow regulating features to selectively provide the flow of wastewater 210 into root chamber 172. Specifically, according to the illustrated embodiment, auxiliary water supply system may include a wastewater supply pump 224 that is fluidly coupled to wastewater tank 222 for providing wastewater 210 through a wastewater conduit 226 into root chamber 172, as described in more detail below.

Notably, there are several conditions of hydration system 180 during which may be undesirable to use primary water supply system 200 to hydrate plants 124. For example, if a user fails to replenish freshwater 202 within water supply tank 204, primary water supply system 200 may not be capable of providing the desired hydration to plants to support their growth or keep them alive. By contrast, if wastewater tank 222 is full such that further supply of freshwater 202 may result in an overflowing tank, you may be desirable to stop the operation of primary water supply system (even if freshwater 202 is available). Accordingly, if controller 196 detects that water supply tank 204 is empty (e.g., via a float sensor or other water level sensor) or that wastewater tank 222 is full (e.g., via a float sensor or other water level sensor), auxiliary water supply system 220 may be used to hydrate plants 124, e.g., using wastewater 210 from auxiliary water supply system 220.

According to exemplary embodiments, hydration system 180 may include an accumulator (not shown) that is generally configured for receiving and storing pressurized water or liquid. In this regard, the term “accumulator” may generally be used to refer to any suitable device for receiving, storing, and distributing pressurized liquid. For example, the accumulator may be a sealed container containing an air bladder that is compressed as pressurized water is supplied into the accumulator all. The air within the air bladder may be compressed to maintain the pressure of the water within the accumulator and may expand to discharge water when the supply conduit 208 is no longer pressurized. In this manner, the accumulator may operate to absorb hydraulic disturbances and maintain a substantially constant pressure and flow rate for the freshwater 202. It should be appreciated that other means for maintaining the hydraulic pressure within the accumulator may be used while remaining within the scope of the present subject matter. According to exemplary embodiments, hydration system 180 may further include one or more valves positioned throughout hydration system 180 for regulating the flow of liquid or other fluid flows therein.

According to exemplary embodiments, a filtration system 230 is integrated into hydration system 180 of gardening appliance 100 that includes one or more filters that are generally configured for receiving and filtering freshwater 202. Specifically, according to the exemplary embodiments, filtration system 230 includes a reverse osmosis filter. As used herein, the term “reverse osmosis filter” is generally intended refer to any suitable number, type, and configuration of filters that implement a reverse osmosis process to remove contaminants from freshwater 202. For example, according to an exemplary embodiment, the reverse osmosis filter may utilize membrane or hollow fiber separation technologies, although any other suitable reverse osmosis technology may be used according to alternative embodiments.

In this regard, reverse osmosis is generally the process of filtering water using a semipermeable membrane that allows freshwater to permeate from a contaminated side of the membrane, through the semipermeable membrane, and into a filtered side of the semipermeable membrane. Contaminants, e.g., dissolved solids, in freshwater 202 are not permitted to pass through the semipermeable membrane create a liquid with concentrated contaminants. Further details regarding the reverse osmosis process are omitted here for brevity but should be understood by one of ordinary skill in the art.

According to the exemplary embodiments, filtration system 230 may further include one or more prefilters that filter freshwater 202 before passing it into the reverse osmosis filter. For example, the prefilters may include an activated carbon filter (not shown) that reduces multiple organic compounds (VOCs), chlorine, and any other contaminants that may result in a bad taste or odor freshwater 202. It should be appreciated that any suitable number, type, and configuration of filters maybe used according to exemplary embodiments.

According to exemplary embodiments, hydration system 180 may further include a nutrient dosing system (not shown) that is generally configured for facilitating the distribution of nutrient-rich liquid throughout gardening appliance 100 for improved plant growth. In this regard, for example, the nutrient dosing system may include a nutrient supply and a mixing system that provides a flow of nutrients in the desired concentrations. The nutrient dosing system may include replaceable or refillable nutrient cartridges that are filled with nutrients in concentrated form or may receive a nutrient supply from any other suitable location. As used herein, the term “nutrients” and the like are intended generally to refer to any substances which facilitate improved growth of plants 124. For example, according to exemplary embodiments, nutrients may include calcium, magnesium, potassium, sulfur, copper, zinc, boron, molybdenum, iron, cobalt, manganese, phosphorous, and chlorine. Nutrients may also be used to refer to chemicals or substances that can be used to adjust a pH of the nutrient mixture, a level of total dissolved solids (TDS), etc. According to alternative embodiments, any other suitable mixture or combination of compositions for encouraging root growth and plant growth may be used while remaining within the scope of the present subject matter.

The nutrient dosing system may further include features for discharging selected flow rates or volumes of nutrients, such as pumps or discharge mechanisms. According to exemplary embodiments, the nutrient dosing system may include a plurality of nutrient dosing pumps, such as solenoid-actuated plunger valves, a dedicated pump (e.g., such as a peristaltic pump), or a flow regulating valve that may selectively dispense any desired nutrients, at desired rates, and at desired times. Thus, the nutrient dosing system provides any suitable number, type, and combinations of nutrients at any suitable flow rates and volumes for mixing within hydration system 180.

For example, according to exemplary embodiments, the nutrient dosing system may include a plurality of flow regulating valves, discharge mechanisms, pumps, and supply nozzles that are all in operative communication with controller 196 of gardening appliance 100. As such, controller 196 may make informed decisions regarding the desired flow of diluted nutrient mixture based on the type, quality, and position of plants 124 within grow tower 160. For example, controller 196 may regulate the type of nutrients supplied, the nutrient concentrations, which nozzles receive the flow of diluted nutrients, etc. In addition, the nutrient dosing system may make other adjustments that facilitate improved plant growth and ecosystem health within gardening appliance 100.

According to the exemplary embodiments, hydration system 180 may further include a mixing tank (not shown) that is generally configured for mixing freshwater 202 with nutrients from the nutrient dosing system. The mixing tank may include any suitable agitators, stirrers, or other devices for creating a flow of nutrient rich mixture. In general, the mixing tank includes an internal mixing reservoir that receives water and nutrients to create the freshwater 202. As explained briefly above, controller 196 of gardening appliance 100 may independently regulate the nutrient dosing system to provide the desired amount and concentration of nutrients into the mixing tanks and the resulting freshwater 202 may be selectively discharge through the one or more discharge valves 182.

As explained briefly above, evaporator 146 of sealed system 142 generates condensate during operation. This condensate is typically directed into an external drain or wastewater reservoir, e.g., such as the wastewater tank 222. However, storage of this condensate requires a larger wastewater tank 222 and/or requires that the reservoir be emptied more often. In addition, the condensate is not typically used in a productive manner. For example, collected condensate may be used to hydrate plants 124, thereby reducing the water supply burden on water supply tank 204 and requiring less frequent filling of any water supply tanks. Accordingly, aspects of the present subject matter are directed to systems and methods for utilizing collected condensate for improved water usage efficiency, wastewater storage efficiency, and performance of gardening appliance 100.

Specifically, referring still to FIG. 8, hydration system 180 may further include a drip tray 240 that is positioned below evaporator 146 and which defines a reservoir 242 for collecting condensate that is formed by the evaporator 146 while sealed system 142 is operating. In general, drip tray 240 may be formed from any suitable material and may be positioned in any suitable manner for collecting condensate under the force of gravity. However, it should be appreciated that variations and modifications may be made to drip tray 240 while remaining within the scope of the present subject matter.

For example, according to the illustrated embodiment, gardening appliance 100 may include an evaporator housing 244 that generally defines an evaporator plenum 246 within which evaporator 146 is received. In general, a bottom wall 248 of evaporator housing 244 is positioned immediately below evaporator 146 along the vertical direction V and is positioned between reservoir 242 and evaporator plenum 246. According to exemplary embodiments, bottom wall 248 may include a sloped surface for facilitating the collection of the condensate that drips off evaporator 146 during operation. In addition, the bottom wall 248 may define one or more apertures 250 that permit the condensate to flow from evaporator plenum 246 through bottom wall 248 and into reservoir 242.

Notably, according to the illustrated embodiment, evaporator plenum 246 is positioned directly above reservoir 242 along the vertical direction V. In addition, reservoir 242 is positioned directly above root chamber 172 along the vertical direction V. In this manner, by positioning evaporator 146 at the top of gardening appliance 100, convective cooling of climate-controlled chamber 122 may be achieved. In addition, the condensate generated by evaporator 146 may be collected and repurposed relying at least in part on gravity.

As explained above, wastewater supply pump 224 may be generally configured for pumping wastewater 210 through wastewater conduit 226 and into root chamber 172 in situations where is undesirable to use freshwater 202 from primary water supply system. According to an exemplary embodiment of the present subject matter, a discharge end of wastewater conduit 226 may be positioned in or over drip tray 240 such that operation of water supply pump 224 supplies wastewater 210 into the tray 240. Similar to collected condensate, this wastewater 210 may drip out of reservoir 242 through apertures 250 to hydrate plants in situations where freshwater 202 cannot or should not be supplied. Notably, using drip tray 240 to dispense this water instead of supply conduit 208 and misting nozzles 182 may be desirable to avoid clogging of the nozzles 182 with particulates or other contaminants within wastewater 210.

Notably, gardening appliance 100 may further include features for improving the distribution of freshwater 202 and/or wastewater 210 when discharged into root chamber 172. For example, referring now briefly to FIG. 3, grow tower 160 may include one or more water collecting ribs 260 that extend from the inner surface 262 of grow tower 160 into root chamber 172. In general, these water collecting ribs 260 may be sized, positioned, and oriented toward apertures 174 of grow tower 160 for collecting and directing collecting water toward apertures 174, e.g., to hydrate plants 124 positioned therethrough. According to exemplary embodiments, water collecting ribs 260 may be positioned above apertures 174 along the vertical direction V, e.g., to facilitate gravity-driven flow of collected condensate toward apertures 174.

It should be appreciated that grow tower 160 and/or water collecting ribs 260 may be formed from any suitably rigid material. For example, according to exemplary embodiments, grow tower 160 and water collecting ribs 260 may be formed by injection molding, e.g., using a suitable plastic material, such as injection molding grade Polybutylene Terephthalate (PBT), Nylon 6, high impact polystyrene (HIPS), or acrylonitrile butadiene styrene (ABS). Alternatively, according to the exemplary embodiment, these components may be compression molded, e.g., using sheet molding compound (SMC) thermoset plastic or other thermoplastics. According to still other embodiments, portions of grow tower 160 may be formed from any other suitable rigid material.

Now that the construction of gardening appliance 100 has been presented according to an exemplary embodiment, an exemplary method 300 of operating a gardening appliance will be described. Although the discussion below refers to the exemplary method 300 of operating gardening appliance 100, one skilled in the art will appreciate that the exemplary method 300 is applicable to the operation of a variety of other gardening appliances. In exemplary embodiments, the various method steps as disclosed herein may be performed by controller 196 or a separate, dedicated controller.

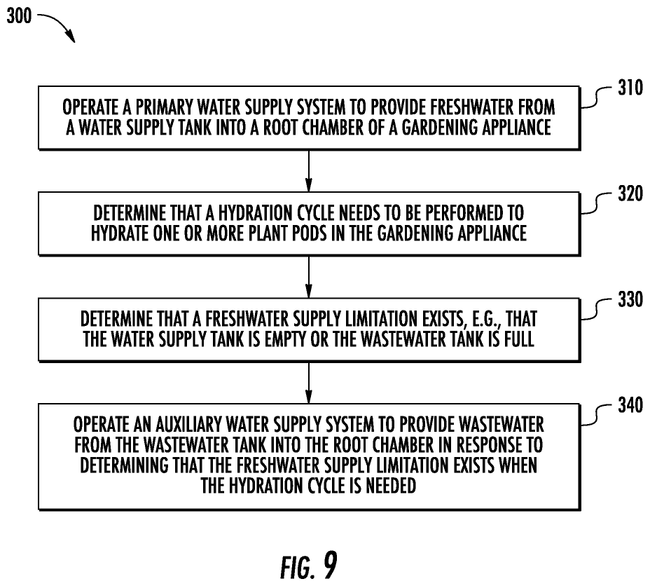

Referring now to FIG. 9, method 300 includes, at step 310, operating a primary water supply system to provide freshwater from a water supply tank into a root chamber of a gardening appliance. In this regard, continuing the example from above, primary water supply system 200 may be used under normal operating conditions to provide freshwater 202 into root chamber 172 and onto the roots of plants 124. Step 320 may include determining that a hydration cycle needs to perform to hydrate one or more plants in gardening appliance. In this regard, for example, a hydration cycle may be triggered based on a predetermined watering schedule, based on information related to the health of plants, or based on any other condition.

Step 330 may generally include determining that a freshwater supply limitation exist. In this regard, as explained briefly above, a “freshwater supply limitation” may generally refer to situations where it is undesirable to provide freshwater 202 from primary water supply system 200. For example, one reason it may be undesirable (or not possible) to supply such freshwater 202 may be when the water supply tank 204 is empty. Accordingly, if controller 196 determines that a supply water level of freshwater 202 in water supply tank 204 is below a predetermined low-water threshold, and also determines that a hydration cycle is needed, controller 196 may utilize auxiliary water supply system 220 to meet the hydration needs of the plants 124. By contrast, even if freshwater 202 is available in water supply tank 204, it may be undesirable to use such freshwater when the wastewater tank 222 is already full (e.g., as an overflow may occur). Accordingly, controller 196 may determine that a wastewater level of wastewater 210 in wastewater tank 222 is above a predetermined high water threshold, indicating a freshwater supply limitation. It should be appreciated that other situations may arise which qualify as a freshwater supply limitation while remaining within the scope of the present subject matter.

Step 340 generally includes operating auxiliary water supply system to provide wastewater from the wastewater tank into the root chamber in response to determining that the freshwater supply limitation exists (e.g., as determined at step 330) when the hydration cycle is needed (e.g., as determined at step 320). In this regard, freshwater supply pump 206 may remain off and wastewater supply pump 224 may operate to draw wastewater 210 through wastewater conduit. The wastewater 210 may be discharged and a drip tray 240 where it may be slowly released or dripped through apertures 250 into root chamber 172 and onto the roots of plants 124. In this manner, auxiliary water supply system 220 may be used to provide necessary hydration in situations where freshwater 202 is not able to be supplied.

FIG. 9 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of method 300 are explained using gardening appliance 100 as an example, it should be appreciated that this method may be applied to the operation of any other suitable gardening appliance.

As explained herein, aspects of the present subject matter are generally directed to an aeroponic growing appliance featuring a secondary wastewater recirculation path to reuse the wastewater until the user takes the necessary steps of refilling the empty freshwater reservoir. The aeroponic appliance may use nozzles to mist water inside the root chamber directly onto the roots. To create a fine mist, the size of openings of the nozzles are very small in diameter. Hence the nozzles are prone to clogging in case the water contains debris or undissolved particles.

Accordingly, to prevent wastewater from clogging the spray nozzles, aspects of the present subject matter are directed to a secondary method to deliver water to the roots. Specifically, the secondary method may contain water dripping apparatus or other methods to flow water in such a way that the roots come in contact with the water, similar to the nutrient film technique wherein the roots are in contact with a thin film formed by the water. For example, the wastewater may be dripped from an evaporator mounted near the top of the appliance. In addition, protrusions may be formed on the inner wall of the root chamber to guide the dripping water to come in contact with the roots. According to exemplary embodiments, the secondary system is activated only when the freshwater tank is empty.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A gardening appliance defining a vertical direction, the gardening appliance comprising:
a liner positioned within a cabinet and defining a grow chamber;
a grow tower rotatably mounted within the liner, the grow tower defining a root chamber and a plurality of apertures for receiving one or more plant pods;
a primary water supply system for selectively providing freshwater into the root chamber;
an auxiliary water supply system comprising a wastewater tank for storing wastewater and selectively providing the wastewater into the root chamber; and
a controller in operative communication with the primary water supply system and the auxiliary water supply system, the controller being configured to:
determine that a hydration cycle needs to be performed to hydrate the one or more plant pods;
determine that a freshwater supply limitation exists; and
operate the auxiliary water supply system to provide the wastewater from the wastewater tank into the root chamber in response to determining that the freshwater supply limitation exists when the hydration cycle is needed.

2. The gardening appliance of claim 1, wherein the primary water supply system comprises:
a water supply tank for storing the freshwater;
a freshwater supply pump fluidly coupled to the water supply tank; and
a discharge nozzle fluidly coupled to the freshwater supply pump for selectively spraying the freshwater into the root chamber.

3. The gardening appliance of claim 2, wherein determining that the freshwater supply limitation exists comprises:
determining that a supply water level of the freshwater in the water supply tank is below a low water threshold.

4. The gardening appliance of claim 2, further comprising:
a filter positioned downstream of the freshwater supply pump.

5. The gardening appliance of claim 1, wherein determining that the freshwater supply limitation exists comprises:
determining that a wastewater level of the wastewater in the wastewater tank is above a high water threshold.

6. The gardening appliance of claim 1, further comprising:
a sump positioned at a bottom of the grow chamber for collecting and directing the wastewater into the wastewater tank.

7. The gardening appliance of claim 1, wherein the auxiliary water supply system comprises:
a wastewater supply pump fluidly coupled to the wastewater tank for providing the wastewater into the root chamber.

8. The gardening appliance of claim 7, further comprising:
a drip tray positioned above the grow tower, the drip tray defining a plurality of apertures for dripping the wastewater into the root chamber; and
a wastewater supply conduit fluidly coupled to the wastewater supply pump for directing the wastewater into the drip tray.

9. The gardening appliance of claim 8, further comprising:
a sealed system comprising an evaporator, a condenser, an expansion device, and a compressor; and
an evaporator housing defining an evaporator plenum for receiving the evaporator, wherein a bottom wall of the evaporator housing is positioned between the drip tray and the evaporator plenum, and wherein the bottom wall defines at least one aperture to permit the condensate to flow from the evaporator plenum into the drip tray.

10. The gardening appliance of claim 9, wherein the evaporator plenum is positioned above the root chamber along the vertical direction.

11. The gardening appliance of claim 1, further comprising:
one or more water collecting ribs extending from an inner surface of the grow tower into the root chamber, the one or more water collecting ribs being oriented for directing the wastewater toward the one or more plants pods.

12. A hydration system for a gardening appliance, the gardening appliance comprising a liner positioned within a cabinet and a grow tower rotatably mounted within the liner, the grow tower defining a root chamber and a plurality of apertures for receiving one or more plant pods, the hydration system comprising:
a primary water supply system for selectively providing freshwater into the root chamber;
an auxiliary water supply system comprising a wastewater tank for storing wastewater and selectively providing the wastewater into the root chamber; and
a controller in operative communication with the primary water supply system and the auxiliary water supply system, the controller being configured to:
determine that a hydration cycle needs to be performed to hydrate the one or more plant pods;
determine that a freshwater supply limitation exists; and
operate the auxiliary water supply system to provide the wastewater from the wastewater tank into the root chamber in response to determining that the freshwater supply limitation exists when the hydration cycle is needed.

13. The hydration system of claim 12, wherein the primary water supply system comprises:
a water supply tank for storing the freshwater;
a freshwater supply pump fluidly coupled to the water supply tank; and
a discharge nozzle fluidly coupled to the freshwater supply pump for selectively spraying the freshwater into the root chamber.

14. The hydration system of claim 13, wherein determining that the freshwater supply limitation exists comprises:
determining that a supply water level of the freshwater in the water supply tank is below a low water threshold.

15. The hydration system of claim 13, further comprising:
a filter positioned downstream of the freshwater supply pump.

16. The hydration system of claim 12, wherein determining that the freshwater supply limitation exists comprises:
determining that a wastewater level of the wastewater in the wastewater tank is above a high water threshold.

17. The hydration system of claim 12, further comprising:
a sump positioned at a bottom of the grow tower for collecting and directing the wastewater into the wastewater tank.

18. The hydration system of claim 12, wherein the auxiliary water supply system comprises:
a wastewater supply pump fluidly coupled to the wastewater tank for providing the wastewater into the root chamber.

19. The hydration system of claim 18, further comprising:
a drip tray positioned above the grow tower, the drip tray defining a plurality of apertures for dripping the wastewater into the root chamber; and
a wastewater supply conduit fluidly coupled to the wastewater supply pump for directing the wastewater into the drip tray.

20. The hydration system of claim 19, further comprising:
a sealed system comprising an evaporator, a condenser, an expansion device, and a compressor; and
an evaporator housing defining an evaporator plenum for receiving the evaporator, wherein a bottom wall of the evaporator housing is positioned between the drip tray and the evaporator plenum, and wherein the bottom wall defines at least one aperture to permit the condensate to flow from the evaporator plenum into the drip tray.
